(19) United States
(12) Patent Application Publication
(10) Pub. No.: US 2014/0168057 A1
(43) Pub. Date: Jun. 19, 2014

(54) GYRO AIDED TAP GESTURE DETECTION

(71) Applicant: QUALCOMM INCORPORATED, San Diego, CA (US)

(72) Inventors: Disha Ahuja, San Jose, CA (US); Carlos M. Puig, Santa Clara, CA (US); Ashutosh Joshi, San Diego, CA (US)

(73) Assignee: QUALCOMM Incorporated, San Diego, CA (US)

(21) Appl. No.: 13/887,695

(22) Filed: May 6, 2013

Related U.S. Application Data
(60) Provisional application No. 61/737,018, filed on Dec. 13, 2012.

(51) Int. Cl. G06F 3/01

(52) U.S. Cl. CPC G06F 3/017
USPC 345/156

(57) ABSTRACT

Methods, systems, computer-readable media, and apparatuses for tap detection in a mobile device are presented. In some embodiments, the method may comprise storing, by a mobile device, a first data sample from an accelerometer sensor and a second data sample from a gyroscope sensor. Additionally, the method may comprise processing a plurality of data samples. The plurality of data samples can include the first data sample or the second data sample. Optionally, in one embodiment, the method may comprise suppressing a tap that has been classified as a false detection based on at least one of the plurality of data samples. Subsequently, the method may comprise determining an occurrence of a tap at a mobile device based on the results of the processing.

### CROSS-REFERENCES TO RELATED APPLICATIONS

The present application is a non-provisional of and claims the benefit and priority under 35 U.S.C. 119(e) of U.S. Provisional App. No. 61/737,018 filed Dec. 13, 2012, entitled Gyro Aided Tap Gesture Detection, and the entire contents of which are incorporated herein by reference for all purposes.

### BACKGROUND

The subject matter disclosed herein relates generally to gesture detection.

Electronic devices can be equipped with a variety of sensors and inputs to monitor and discover information about the environment of a device. For example, a device may have an accelerometer to measure aspects of device movement.

Programs or applications running on a device may make frequent use of the data received from sensors such as the accelerometer, and may frequently process the incoming sensor data to provide an enhanced user experience. Some devices use accelerometer sensor data to detect interaction with a device. However, the capabilities of an accelerometer to detect interaction with a device may be limited. For example, when a device changes orientation the accelerometer may not be able to provide for accurate gesture reading or may provide false positives.

Therefore, new and improved sensor data processing techniques are desirable.

### BRIEF SUMMARY

Methods, systems, computer-readable media, and apparatuses for tap detection in a mobile device are presented.

In some embodiments, a method for tap detection may be disclosed. The method may comprise storing, by a mobile device, a first data sample from an accelerometer sensor and a second data sample from a gyroscope sensor. Additionally, the method may comprise processing a plurality of data samples. The plurality of data samples can include the first data sample or the second data sample Optionally, in one embodiment, the method may comprise suppressing a tap that has been classified as a false detection based on at least one of the plurality of data samples. Subsequently, the method may comprise determining an occurrence of a tap at a mobile device based on the results of the processing.

According to another embodiment, a device is disclosed. The device may comprise one or more processors and memory storing computer-readable instructions. When executed by the one or more processors, the instructions may cause the device to: receive a first data sample from an accelerometer sensor; receive a second data sample from a gyroscope sensor; process a plurality of data samples, wherein the plurality of data samples includes the first data sample or the second data sample; and determine an occurrence of a tap at a mobile device based on the results of the processing.

According to another embodiment, one or more computer-readable media storing computer-executable instructions for detecting a tap in a mobile device are disclosed. When executed, the computer-executable instructions may cause one or more computing devices included in the mobile device to: receive a first data sample from an accelerometer sensor; receive a second data sample from a gyroscope sensor; process a plurality of data samples, wherein the plurality of data samples includes the first data sample or the second data sample; and determine an occurrence of a tap at a mobile device based on the results of the processing.

According to another embodiment, an apparatus for detecting a tap in a mobile device is disclosed. The apparatus may comprise: means for receiving a first data sample from an accelerometer sensor; means for receiving a second data sample from a gyroscope sensor; means for processing a plurality of data samples, wherein the plurality of data samples includes the first data sample or the second data sample; and means for determining an occurrence of a tap at a mobile device based on the results of the processing.

### BRIEF DESCRIPTION OF THE DRAWINGS

Aspects of the disclosure are illustrated by way of example. In the accompanying figures, like reference numbers indicate similar elements, and:

FIG. 1 is a simplified block diagram of a tap gesture detection system, according to one embodiment of the present invention;

FIG. 2 is a simplified block diagram illustrating one embodiment of potential tap directions as related to an example device;

FIG. 3A depicts a simplified flow chart depicting the operation of a tap event module, according to one embodiment;

FIG. 3B depicts a simplified flow chart of the process for tap detection, according to one embodiment;

FIG. 4 illustrates a device, the X, Y, and Z axes and rotational motion as recorded by the gyroscope;

FIG. 5 illustrates a chart of an example tap signature based on raw acceleration data, in one embodiment;

FIG. 6 illustrates an enlarged section of the chart of FIG. 5, in one embodiment;

FIG. 7 is a flow chart illustrating the operation of the Feature Module, in one embodiment;

FIG. 8 illustrates a block diagram of a Tap Event Module, in one embodiment;

FIG. 9 illustrates a flow diagram of one embodiment of a method for tap detection and direction determination;

FIG. 10 illustrates an example chart of data sampled at a low frequency, in one embodiment; and

FIG. 11 illustrates a zoomed-in example of data sampled at a higher frequency, in one embodiment.

### DETAILED DESCRIPTION

The word “exemplary” or “example” is used herein to mean “serving as an example, instance, or illustration.” Any aspect or embodiment described herein as “exemplary” or as an “example” in not necessarily to be construed as preferred or advantageous over other aspects or embodiments.

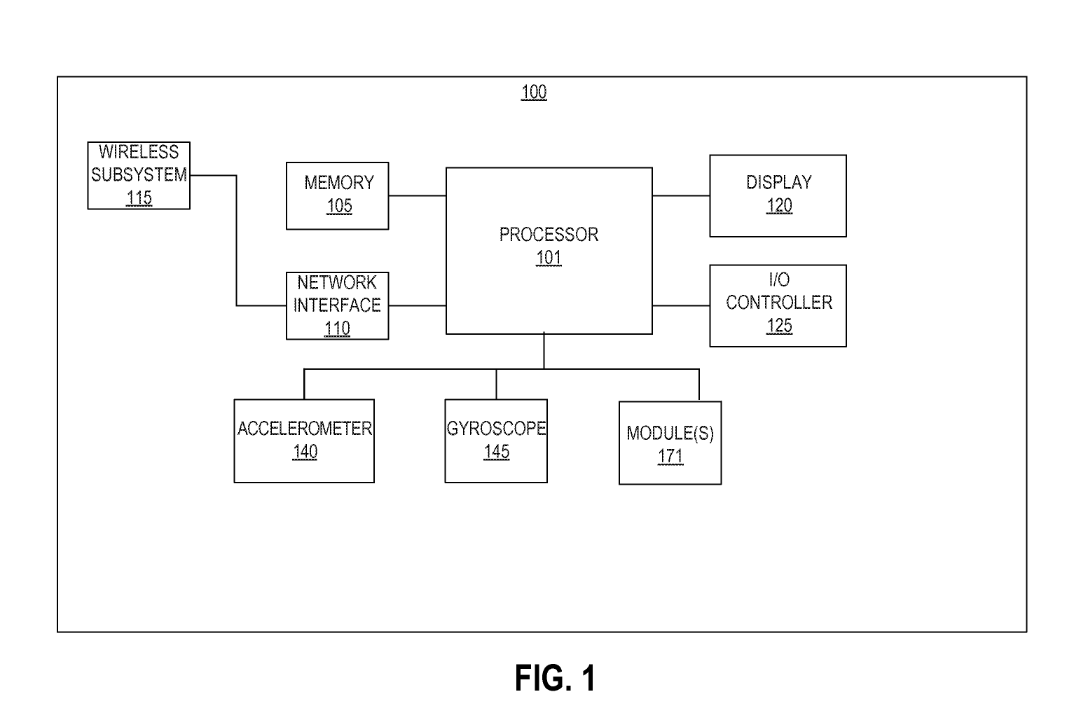

FIG. 1 is a block diagram illustrating an exemplary data processing system in which embodiments of the invention may be practiced. The system may be a device 100, which may include one or more processors 101, a memory 105, I/O controller 125, and network interface 110. Device 100 may also include a number of device sensors coupled to one or more buses or signal lines further coupled to the processor 101. It should be appreciated that device 100 may also include a display 120, a user interface (e.g., keyboard, touch-screen, or similar devices), a power device (e.g., a battery), as well as other components typically associated with electronic devices.

In some embodiments device 100 may be a mobile or non-mobile device. Network interface 110 may also be coupled to a number of wireless subsystems 115 (e.g., Bluetooth, WiFi, Cellular, or other networks) to transmit and receive data streams through a wireless link to/from a wireless network, or may be a wired interface for direct connection to networks (e.g., the Internet, Ethernet, or other wireless systems). Thus, device 100 may be a: mobile device, wireless device, cell phone, personal digital assistant, mobile computer, tablet, personal computer, laptop computer, or any type of device that has processing capabilities.

Device 100 can include sensors such as an accelerometer(s) 140 and gyroscope(s) 145. Memory 105 may be coupled to processor 101 to store instructions for execution by processor 101. In some embodiments, memory 105 is non-transitory. Memory 105 may also store one or more models or modules to implement embodiments described below. Memory 105 may also store data from integrated or external sensors.

In addition, memory 105 may store application program interfaces (APIs) for accessing modules 171 (e.g., tap event module, tap detection module, motion axes module, axes anomaly module, tap direction module, and tap rejection module) described in greater detail below. It should be appreciated that embodiments of the invention as will be hereinafter described may be implemented through the execution of instructions, for example as stored in the memory 105 or other element, by processor 101 of device 100 and/or other circuitry of device 100 and/or other devices. Particularly, circuitry of device 100, including but not limited to processor 101, may operate under the control of a program, routine, or the execution of instructions to execute methods or processes in accordance with embodiments of the invention.

For example, such a program may be implemented in firmware or software (e.g. stored in memory 105 and/or other locations) and may be implemented by processors, such as processor 101, and/or other circuitry of device 100. Further, it should be appreciated that the terms processor, microprocessor, circuitry, controller, etc., may refer to any type of logic or circuitry capable of executing logic, commands, instructions, software, firmware, functionality and the like.

Further, it should be appreciated that some or all of the functions, engines or modules described herein may be performed by device 100 itself and/or some or all of the functions, engines or modules described herein may be performed by another system connected through I/O controller 125 or network interface 110 (wirelessly or wired) to device 100. Thus, some and/or all of the functions may be performed by another system and the results or intermediate calculations may be transferred back to device 100. In some embodiments, such other device may comprise a server configured to process information in real time or near real time. In some embodiments, the other device is configured to predetermine the results, for example based on a known configuration of the device 100.

A device 100 may process or compute data received from one or more sensors (e.g., gyroscope or accelerometer) to output and/or report information related to a device input. In one embodiment, instead of or in addition to touch sensors built into the edges of a device, an accelerometer and gyroscope are used to detect taps. In one embodiment, a user of a device 100 can tap on a surface of the device 100 to control an operation of the device 100.

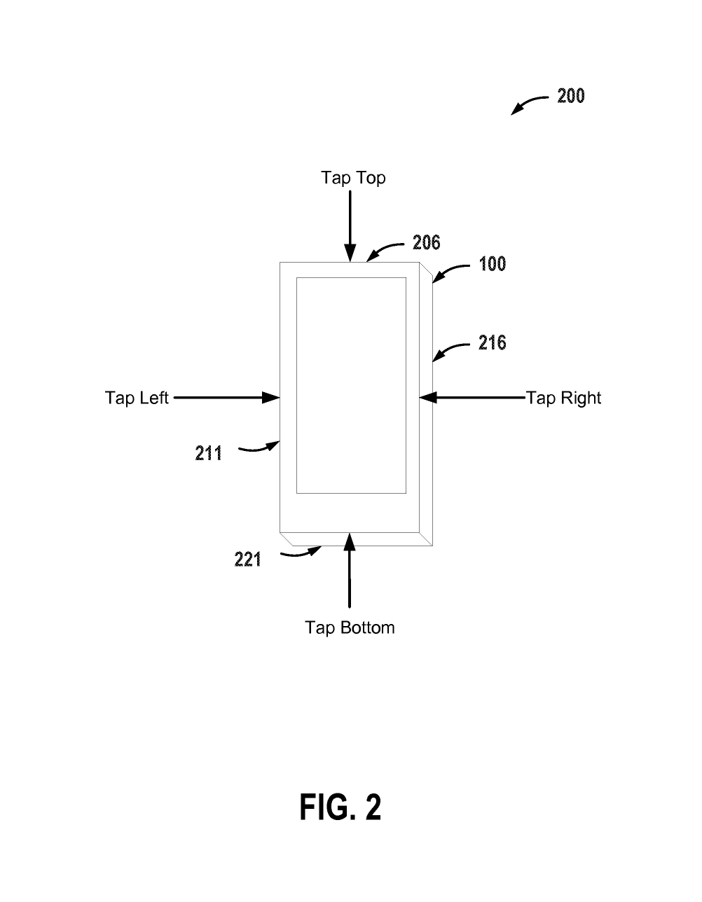

FIG. 2 block diagram illustrates one embodiment of potential tap directions as related to an example device 200. For example, the user can tap (e.g., with a finger, stylus or other object) on an edge (e.g., top edge 206, left edge 211, right edge 216, bottom edge 221) of the device 100. Tapping the edge of the device 100 can trigger a response by the device 100. For example, tapping an edge can cause the device 100 to send a notification that causes software in the device 100 to change an application option or change what is displayed. In one embodiment, tapping the side of the device 100 can cause a photo browsing software installed on the device 100 to change the photo displayed on the display of the device 100. For example, tapping on the left side 211 of the device can cause the photo browsing software to advance to a next photo, while tapping on the right side 216 can cause the software to return to a previous photo. According to another embodiment, tapping on the left side 211 of the device can cause the photo browsing software to return to a previous photo, while tapping on the right side 216 can cause the software to advance to a next photo.

In another example, a tap can move a cursor (e.g., a text cursor in an editor, browser, text messaging application) to a previous or next line after the device 100 determines a tap is received at the top 206 or bottom edge 221 of the device 100. In some instances, the device 100 may also record taps on the left or right of the device and move a text cursor to a previous or next character or word.

Accelerometers are useful for their low power use characteristics. However, factors such as accelerometer sensor placement in the device 100, orientation of the device and sensitivity to user behavior may affect the accuracy of an accelerometer used to detect a tap. Therefore, in one embodiment, the addition of a gyroscope along with the accelerometer can improve the detection of a tap.

For example, in one embodiment the device 100 is a handheld device and tap recording is activated when the device 100 is detected as being held in a user's hand. In some embodiments, tap detection performance may be increased when the device is in a hand, when the user is close to stationary, and when a tap is performed by a fingertip pad or fingernail.

In another embodiment, the accelerometer can gate the use of the gyroscope for power-saving purposes. In some instances, the gyroscope may only be powered on once a detection of a tap has been determined from the data received by the accelerometer. The gyroscope can be used to reject a false positive detection. For example, the data received by the accelerometer may suggest a tap, but by turning on the gyroscope and analyzing the data from the gyroscope, it can be determined that it was not a tap (e.g., the mobile device may have been just placed on a table).

Furthermore, adding a gyroscope can provide robustness to tap detection over using an accelerometer alone. Gyroscopes measure rotational motion rather than linear motion expected from a tap. The gyroscope measurements can still be used to determine the small rotations due to hand motion when tapping a handheld device (e.g., device 100). In one embodiment, the determination of rotation of the tap can assist with tap detection as described in greater detail below.

In some instances, a gyroscope can be used to reject false taps due to orientation changes when the user changes position of a handheld device as described in greater detail below.

For example, the as gyroscope angular acceleration signals provide an opportunity to identify tap axes of motion. In one embodiment, a Tap Event Module (TEM) determines whether a tap occurs and outputs a representation of a direction along an axis (e.g., axes X, Y, or Z). The TEM can use gyroscope signatures, which include the rotational angle (positive or negative) in a tap determination. The gyroscope angular acceleration can correspond to angular acceleration (e.g., angular acceleration equals angular rate divided by time).

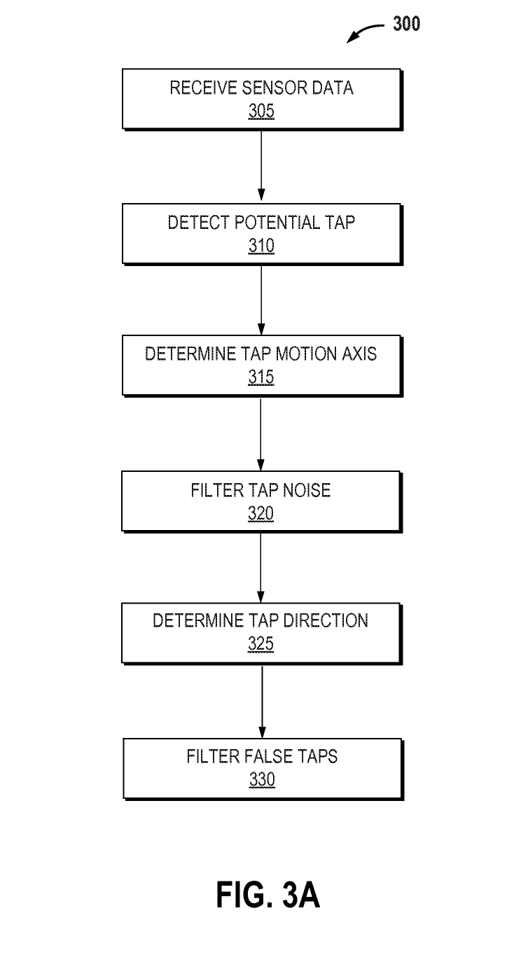

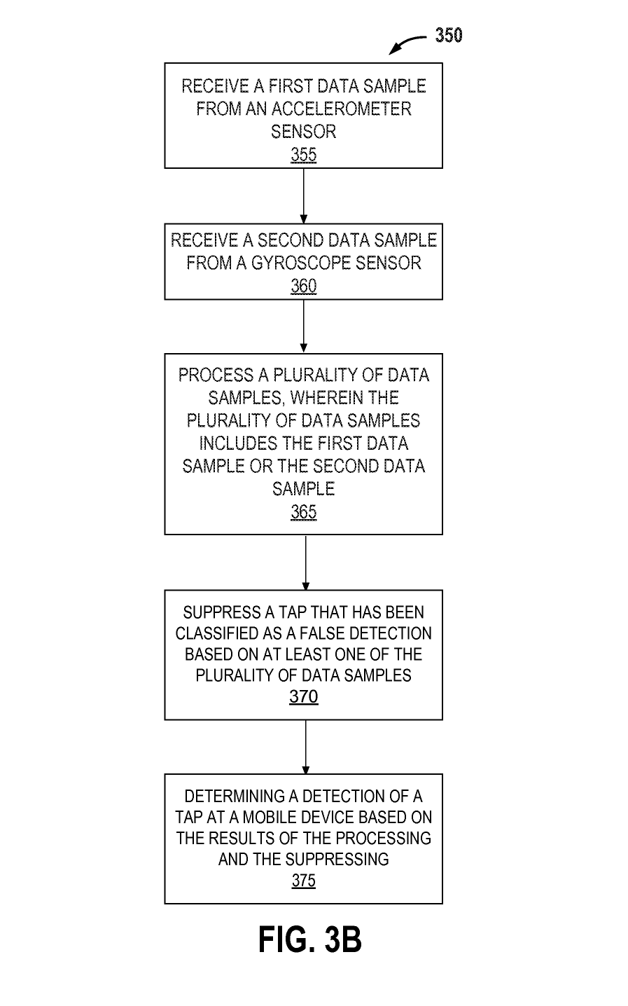

FIG. 3A illustrates a simplified flowchart 300 depicting the operation of a tap event module, according to one embodiment.

At block 305, the TEM can receive sensor data from the accelerometer and gyroscope. For example, a feature module can process raw sensor data from the accelerometer or gyroscope and can send output features to the TEM.

At block 310, the TEM can detect that a potential tap may have occurred based on the sensor data received at block 305. In one embodiment, in order to determine whether a tap has occurred, the TEM can determine a start of a peak and end of a peak in the sensor data received. For example, the start of a peak and end of the peak may be determined when the peak meets a predetermined minimum peak threshold or parameter.

At block 315, the TEM determines one or more tap motion axes based on the signal magnitude from the X, Y, and Z axes. In one embodiment, the TEM can determine the signal magnitude by analyzing a partial section of the sensor data. The partial section can be estimated to contain the tap.

At block 320, the TEM can filter out possible noise. For example, the TEM can determine that one of the axes is predominantly noise and exclude or flag the axis such that the axis is not output in the final determination of motion axes.

At block 325, the TEM can determine the direction of the tap. In one embodiment, a positive magnitude along an axis indicates a positive direction, and a negative magnitude along an axis indicates a negative direction. For example, a positive magnitude on the X-axis may indicate a tap on the left edge of the device 100.

At block 330, the TEM filters out false taps. For example, changing of device orientation quickly from portrait to landscape may trigger a false tap. In one embodiment, a signal-to-noise ratio or minimum signal strength feature can be referenced by the TEM in determining whether a tap is a false tap.

Further details of the TEM are described below. The TEM may also include one or more sub-modules as described below (e.g., a tap detection module, motion axes module, axes anomaly module, tap direction module, tap rejection module). In other embodiments, functionality from one or more modules may be functionally combined into one or more combination modules.

FIG. 3B depicts a simplified flowchart 350 of the process for tap detection, according to one embodiment. At 355, device 100 can receive a first data sample from an accelerometer sensor. The first data sample can be received from accelerometer 140. At 360, device 100 can receive a second data sample from a gyroscope sensor. The second data sample can be received from gyroscope 145.

At 365, device 100 can process a plurality of data samples, wherein the plurality of data samples includes the first data sample and second data samples. According to some embodiments, device 100 can process raw sensor data 705 using windowed jerk feature 710, minimum signal strength feature 715, and signal-to-noise ratio feature 720. The processed data can be used by tap event module 730 to determine if a tap event has occurred.

Additionally, at 370, device 100 can suppress a tap that has been classified as a false detection based on at least one of the plurality of data samples. For example, TEM 730 can classify a tap as a false detection based on the sensor data received from accelerometer 140 and gyroscope 145. In some instances, tap rejection module 825 can be used to suppress a tap that has been classified as a lase detection.

Furthermore, at 375, device 100 can determine a detection of a tap on the device based on the results of the processing and the suppressing. As described herein, tap event module 730 (e.g., tap detection module 805, motion axes module 810, axes anomaly module 815, tap direction module 820, tap rejection module 825) can process data samples to detect a tap and also suppress false detection of a tap.

Sensor Data

In one embodiment, the device 100 may read or receive data from one or more integrated or external sensors (e.g., one or more of the sensors and inputs described in FIG. 1). Additionally, the device 100 can receive external sensor data from communicatively connected external devices (e.g., via a USB connection or Wi-Fi connection to an external camera) through the I/O controller 125. In some instances, the device 100 can receive raw sensor data for use in feature computation as described below. In other embodiments, an intermediary device or program can pre-process sensor data before feature computation by the device 100. For ease of description, sensor data as used herein refers to unprocessed data (e.g., data received from an accelerometer, gyroscope, or other sensor). In some embodiments, the data output from the accelerometer or gyroscope is considered a signal and the signal may have a related magnitude.

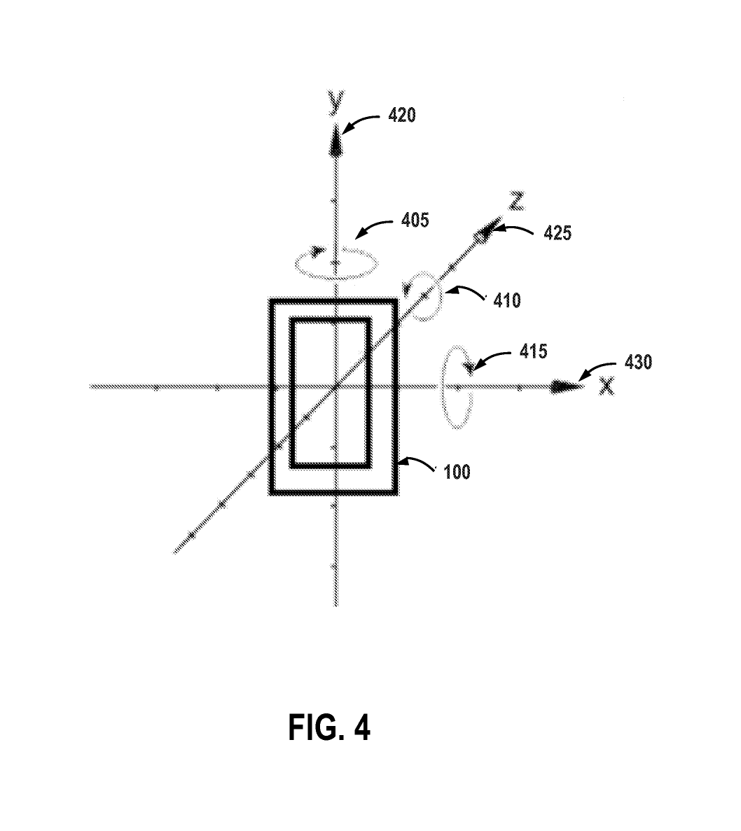

FIG. 4 illustrates a device 100 using a gyroscope 145 to determine the rotational motion related to the axes (i.e., X-axis, Y-axis, Z-axis). Additionally, data from the accelerometer 140 may have attributes of time, acceleration along an X-axis 430, acceleration along a Y-axis 420, and acceleration along a Z-axis 425. As described above, however, sensor data may be received and processed in other forms in other embodiments.

Data from the gyroscope may have attributes of time, rotational motion around an X-axis 415, rotational motion around a Y-axis 405, and rotational motion around a Z-axis 410. As described above, sensor data may also be received and processed in other forms in other embodiments.

The data from a sensor such as an accelerometer 140 or gyroscope 145 may be sampled at a particular frequency (e.g., 50 Hz, 200 Hz, other rate depending on the sampling device and the data requirements). In one embodiment, feature computation is performed on a moment, slice, or window of time selected from a stream or set of data from a sensor. For example, device 100 can compute features from a one second time period selected from a longer sensor data stream (e.g., a ten second time period). For example, raw accelerometer data may be sampled at 60 Hz such that one second of data provides 60 three-dimensional accelerometer vector samples in the X-axis, Y-axis, and Z-axis for a net input size of 180 samples.

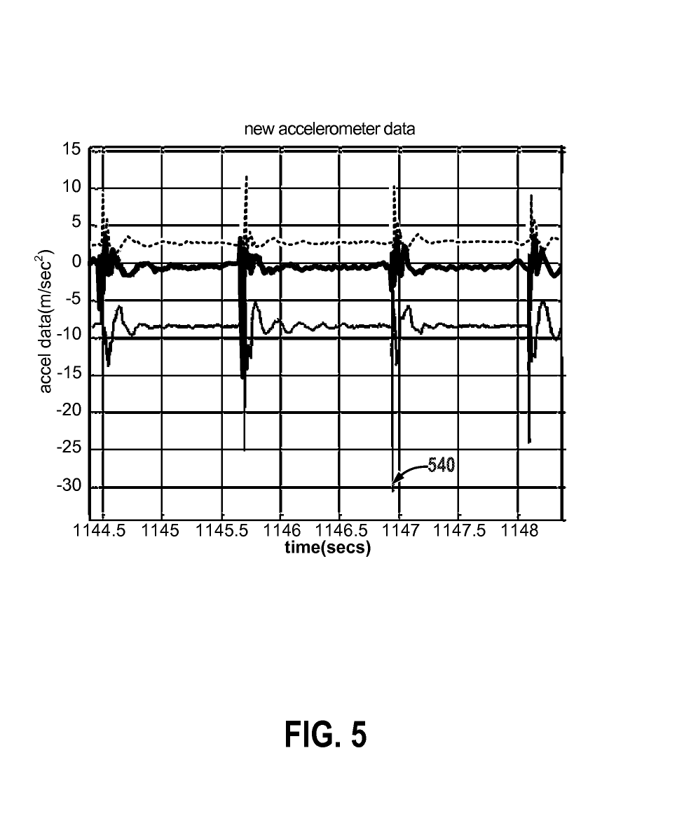

FIG. 5 illustrates an example tap signature based on raw acceleration data, in one embodiment. The point 540 can illustrate a maximum magnitude along the X-axis, which can characterize a right tap.

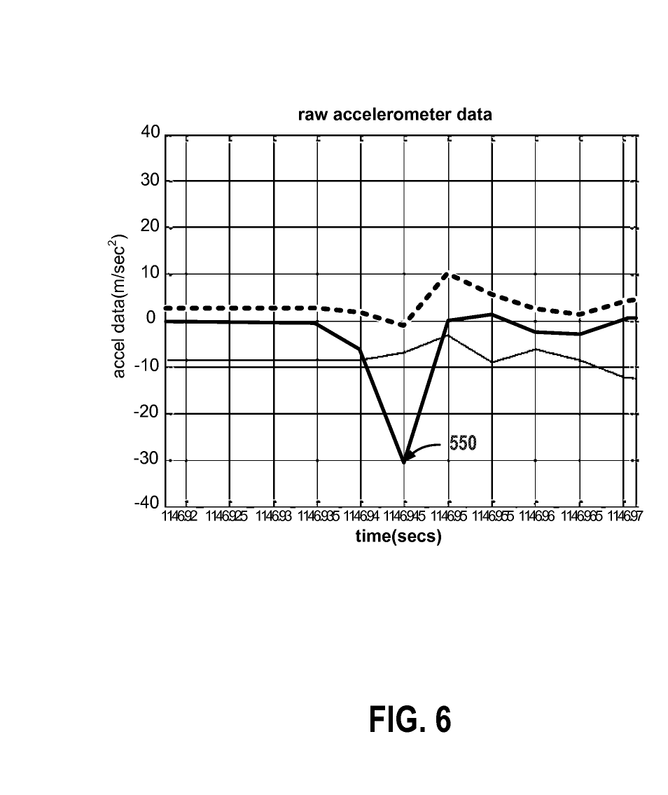

FIG. 6 illustrates a zoomed-in view of a tap signature based on raw acceleration data, in one embodiment. Similarly, the point 550 can illustrate a maximum magnitude along the X-axis, which can characterize a right tap.

Furthermore, the TEM can compare a target data sample to a training data sample (e.g., from a previously computed training set) to classify the target data sample. For example, the TEM may determine that a gyroscope data sensor sample matches a previously recorded (e.g., recorded during tuning or training) gyroscope data sensor sample indicating a tap.

In one embodiment, sensor error detection can compensate for known sensor errors. For example, offset errors are non-zero readings produced when the motion measured by the sensor is actually zero. Additionally, once offset errors have been corrected, scale factor or sensitivity errors can be corrected based on a proportionalto the sensor output reading. Furthermore, cross-axis sensitivity errors can be corrected. Cross signal-to-noise-axis sensitivity error can occur due to the non-orthogonality between the sensor axes. For example, changes in one axis may impact readings on the other axes.

Therefore, a sensor calibration procedure can estimate the values of one or more sensor error types (e.g., as a function of temperature) and can transform the raw sensor readings into calibrated sensor readings through arithmetic operations, using the error estimates described above.

Sensor calibration and tuning may be performed at a factory where the device is produced, by the user following specific instructions, or on-the-fly in normal daily use without requiring any special user intervention. As used herein, auto-calibration can refer to on-the-fly automatic calibration in normal use, after the device 100 has left the original equipment manufacturer (OEM) factory. For example, auto-calibration can be performed inside the sensor device by an embedded microcontroller or by a processor external to the sensor.

In one embodiment, the TEM can compute, process, or extract one or more features from sensor data (e.g., raw data from a gyroscope 140 or accelerometer 150). For example, the TEM can use factory calibrated accelerometer data and offset calibrated gyroscope data to detect taps.

In some embodiments, tunable parameters allow for the TEM to adjust tap determination based on user or device manufacturer settings. For example, the minimum tap impact to produce a specified minimum acceleration is a tunable parameter. In another example, for multiple tap detection, the delay between taps may be specified by an inter-tap delay tunable parameter.

Tap Detection

A tap can be recognized by device 100 as a signal representing an impulse in time with sharp rising and falling edges. A tap can manifest itself as a strong signal along the axis of motion accompanied by a rebound or reaction signal. For example, the impulse time period may be 100 to 250 milliseconds depending on the location of the tap and the user force. In one embodiment, taps are detected in one of three axes X, Y, and Z. In other embodiments, taps are detected in the X and Y directions while the Z axis can be considered noise.

A tap can be characterized by a sharp rising pulse and a rebound (e.g., as charted in FIG. 6 as an example tap corresponding to right tap on device 100). The change in the magnitude may be maximal for the Y-axis signal.

Feature Calculation from Raw Sensor Data

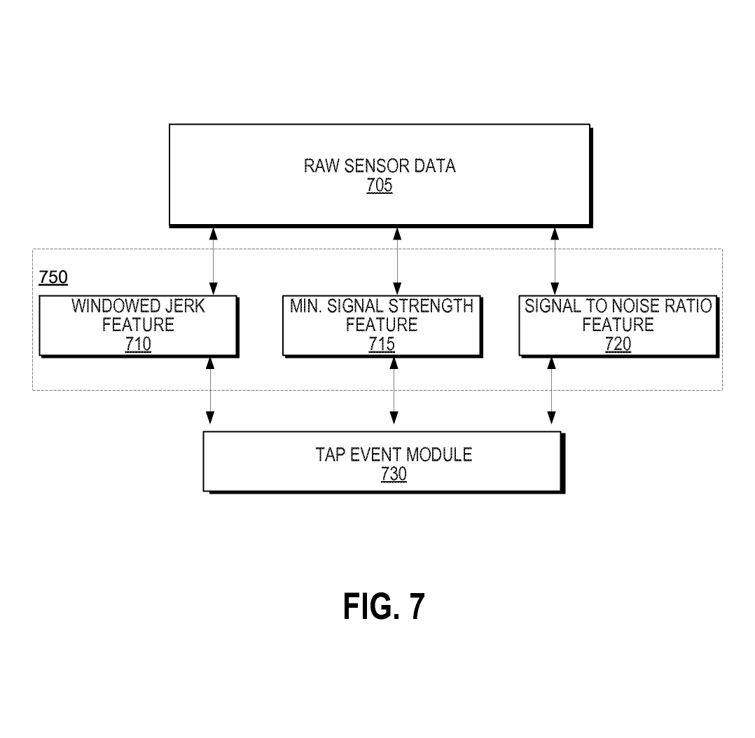

FIG. 7 illustrates a block diagram of a feature module 750, according to one embodiment. In some instances, a feature module 750 can read a stream of raw sensor data 705 (e.g., data from an accelerometer 140 and gyroscope 145) and can output features to the tap event module (TEM) 730. Features can include, but are not limited to, windowed jerk feature 710, minimum signal strength feature 715, and signal-to-noise ratio feature 720. Furthermore, features can be used to determine a tap and tap direction as described in greater detail below.

For example, the sensor data from the accelerometer 140 or gyroscope 145 can be analyzed to determine one or more features. Furthermore, the resulting features can be additionally analyzed to classify the data from the accelerometer 140 or gyroscope 145 to determine whether a tap was performed by a user.

In some instances, classification can be unambiguous when a feature is compared to a training data set and the feature approximately matches (e.g., is within a threshold of) a previously calculated result determined to be associated with a particular classification. Furthermore, the features can be an output from the feature module 750, and the features can be an input to the TEM 730 or TEM sub-modules.

A. Windowed Jerk Feature

Windowed jerk feature 710 may be defined as the difference between the maxima and the minima of the data samples from accelerometer 140 and gyroscope 145 used for detecting tap and the direction of the tap. Compared to a jerk, the windowed jerk can use a moving window and extrema (i.e., maxima, minima) differences for computing modified jerk. In one embodiment, windowed jerk can be based on data samples from accelerometer 140 (e.g., windowed jerk equals acceleration divided by time). In another embodiment, windowed jerk can be based on data samples from gyroscope 140 (e.g., angular acceleration).

Windowed jerk feature 710 can refer to the result or output of computations executed on data (e.g., a target data set from a sensor or other input). In contrast, a traditional jerk can be defined as the derivative of acceleration. For example, an accelerometer windowed jerk may be defined as the difference between the maxima and the minima of the accelerometer data sample used for detecting tap and the direction of the tap. In another embodiment, a gyroscope angular acceleration may be defined as the difference between the maxima and the minima of the gyroscope data sample used for detecting tap and the direction of the tap. In other embodiments, if the data sample used for detecting the tap is different from the data sample used for determining the direction, the windowed jerk can use either data sample.

In some instances, windowed jerk feature can access raw sensor data to capture or output the maximum change that occurs in one or more axes for gyroscope and/or accelerometer data. In comparison to a traditional jerk, the windowed jerk uses a moving window and extrema differences for computing modified jerk.

In one embodiment, windowed jerk feature 710 can process sensor data from accelerometer 140 to determine strong acceleration change occurring along the axes of the tap motion (e.g., X, Y, or Z axes). For example, a left or right tap (e.g., left or right relative to a front surface of a handheld device) may register as a strong X-axis signal change. A top or bottom tap may be recorded as a strong Y-axis signal change. A front surface or back surface tap may be recorded as a strong Z-axis signal change.

In another embodiment, windowed jerk feature 710 can process sensor data from gyroscope 145 (e.g., angular acceleration) to determine strong motion change occurring related to the axes of the tap motion (e.g., X, Y, or Z axes). For example, the derivative of the gyroscope sensor data can be used as a feature for detecting taps. A left or right tap (e.g., left or right relative to a front surface of a handheld device) may register as an X-axis motion signal change. A top or bottom tap may be recorded as a Y-axis motion signal change. A front surface or back surface tap may be recorded as a strong Z-axis motion signal change. Furthermore, the determination of whether a measured or recorded signal change is strong depends on a tunable parameter setting. For example, the tunable parameter may be user editable and/or predetermined by a device manufacturer or software program.

Additionally, windowed jerk feature 710 can find a relatively strong signal between the three axes. By using a windowed jerk instead of jerk, the windowed jerk feature 710 can analyze or process a smaller dataset of the three signals to determine the strongest. By analyzing a smaller dataset, processing power can be saved.

Furthermore, windowed jerk feature 710 can use traditional tap algorithms, such as the difference in consecutive accelerometer samples. The tap timing for consecutive accelerometer samples can be predetermined and/or tunable. In addition, any instantaneous noise or transient noise in the signal may impact the choice of axes of motion, which may be corrected using the sensor error detection.

B. Minimum Signal Strength Feature

In some instances, minimum signal strength feature 715 can detect a potential tap if a jerk or angular acceleration magnitude (e.g., calculated from the sensor data of accelerometer 140 or gyroscope 145) exceeds a pre-defined tap threshold. Subsequently, the absolute jerk or angular acceleration for each axis can be used to determine the dominant axis of motion. Furthermore, to avoid weak taps or taps that cannot be deciphered correctly, minimum signal strength can be set. Additionally, minimum signal strength can be set individually for each axis, and can be different thresholds for each of the axes.

In one embodiment, the minimum signal threshold can depend upon heuristics closely tied to each tap type. Incorporating heuristics allows distinguishing between natural strengths in right or left taps when compared to top or bottom taps. For example, training data may suggest that left and right taps are more likely to have a greater jerk or angular acceleration magnitude than top and bottom taps. Therefore, the minimum signal strength threshold may be set lower for top and bottom taps, or higher for left to right taps in order to obtain the most accurate tap detection. In some embodiments, ambiguous taps are classified as unknown. For example, unknown tap can occur if the device is tapped too close to a corner or if TEM 730 detects both a top/bottom and a left/right tap.

C. Signal-to-Noise Ratio Feature

Signal-to-noise ratio (SNR) feature 720 can determine the strength of a signal (e.g., a signal determined from the sensor data of accelerometer 140 or gyroscope 145) relative to signal noise from other axes. Based on the determination, SNR feature 720 can discriminate between different types of taps.

For example, if a user taps on the right edge of the device 100, the expected axis of motion is in X-direction and signal leakage may bleed over into the Y-axis and Z-axis. Signal leakage to axes other than the expected axis of motion can be classified as noise. In one embodiment, a ratio of the signals between the axes can be used to discriminate from various types of taps. For example, the ratio may be the jerk or angular acceleration magnitude from an axis divided by the jerk or angular acceleration magnitude from one or more other axes (e.g., X/Y or X/Y+Z). In another embodiment, the ratio may be one axis divided by all the axes (e.g., X/X+Y+Z). In yet other embodiments, the ratio may be a first maximum of the three axes divided by a second maximum of the three axes (e.g., maximum(X, Y, Z)/second maximum(X, Y, Z)).

In some instances, SNR Feature 720 may be combined with a minimum signal threshold. For example, if the highest jerk or angular acceleration magnitude is recorded along the X-axis, and two lower magnitude jerks or angular acceleration are recorded along the Y-axis and the Z-axis, a determination may be made that the tap occurred on the X-axis even if the Y-axis and Z-axis may each individually meet their respective minimum signal thresholds.

### II. Tap Event Module

Tap Event Module (TEM) 730 can determine whether a tap occurs and determine a representation of a direction along one of the three axes (i.e., X, Y, or Z). For example, after receiving a tap, TEM 730 may output a determination to an application on the device 100 that a tap was received in a particular direction (e.g., the negative X-direction corresponding with a tap on the right edge of the device). In some instances, TEM 730 can determine and classify a potential tap as a false detection.

In one embodiment, the TEM can use sensor data from accelerometer 140 and gyroscope 145 to increase accuracy of tap detection. Furthermore, the gyroscope can be used to reject false taps based on orientation changes. Accelerometer signatures (i.e., jerk, angular acceleration) may not be unique as the signatures can depend on orientation, sensor location, and user behavior. Gyroscope angular acceleration signals can provide another degree of freedom and an opportunity to identify tap axes of motion. For example, gravity is a constant force (i.e., 9.81 meters per second squared) acting upon an accelerometer. A device may not be able to determine when a force is gravity or a user initiated tap. Therefore, orientation determination assisted by gyroscope sensors can help to isolate gravity from other possible forces acting upon the accelerometer.

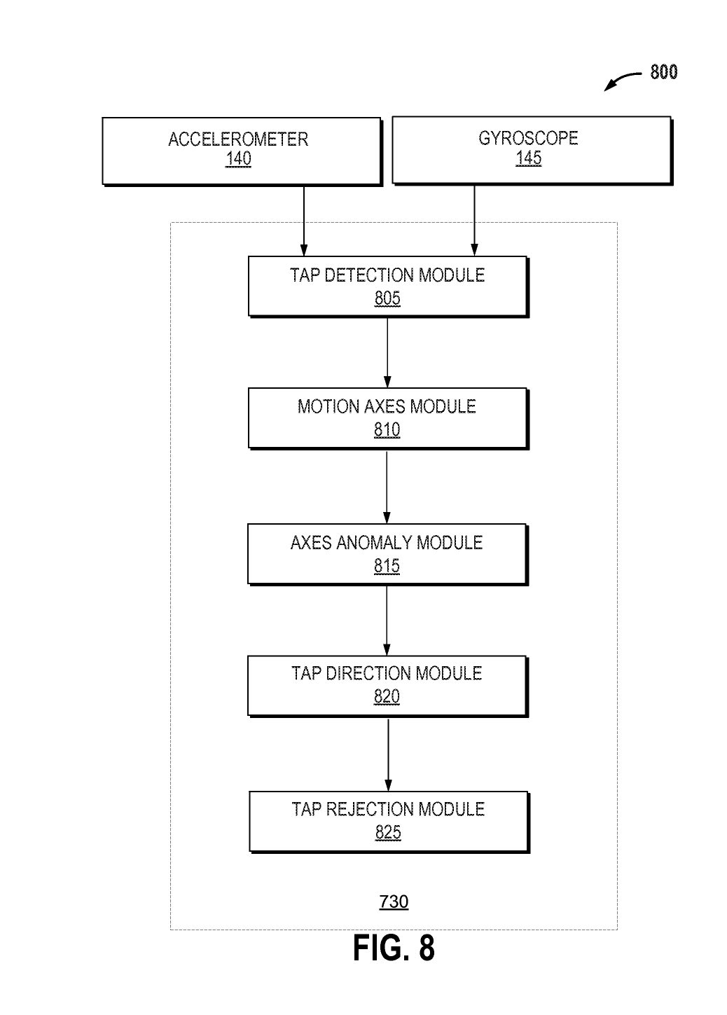

FIG. 8 illustrates a block diagram 800 of TEM 730, according to one embodiment. In some instances, TEM 730 may include a plurality of sub-modules such as a tap detection module 805, motion axes module 810, axes anomaly module 815, tap direction module 820, and tap rejection module 825. In alternate embodiments, TEM 730 may provide a reduced three-step tap detection process to first determine whether a tap occurred, then find the tap axes or motion, and then find tap direction. The TEM may output a tap direction to an application running on the device 100 for use in user navigation.

A. Tap Detection Module

Tap detection can be implemented using a tap detection module (TDM) 805. Potential tap detection may be based on the magnitude of jerk computed from the accelerometer in the X, Y, or Z axes. If either the magnitude of jerk or the absolute jerk on any of the axes exceeds the threshold, a potential tap can be detected. The potential tap may be detected based on regular consecutive samples of jerk in order to enable fast detection of potential taps. Additionally, TDM 805 may use the tap features (e.g., windowed jerk feature 710, minimum signal strength feature 715, SNR feature 720) to detect a tap.

In one embodiment, a sensitivity threshold controls magnitude-based tap sensitivity. The sensitivity threshold may be based on individual components computed as a function of the X, Y or Z axes. In general, the threshold may be stricter when using individual components.

In one embodiment, TDM 805 monitors the tap start time and outputs a result to tap direction module 820. TDM 805 may use the early rise of the jerk or angular acceleration peak in order to determine tap direction (e.g., left from right, top from bottom). TDM 805 can seek to find not only the signal resembling a tap start, but also capture the tap start moment correctly for direction determination. In one embodiment, a directionality threshold is used to tune the directionality based on a user selected parameter or pre-computed parameter.

B. Motion Axes Module

Motion Axes Module (MAM) 810 can determine the axes of motion of a tap. For example, the axes of motion may be a check for the absolute jerk or angular acceleration in the individual axes X, Y, and Z. Sensor location for the device 100 may smudge or add noise from other axes before the true signature can be determined In one embodiment, MAM 810 performs several hierarchical checks to determine the axis of motion heuristically. For example, the MAM 810 may use the tap features described earlier (e.g., windowed jerk feature 710, minimum signal strength feature 715, SNR feature 720) to determine the axes of motion.

### i. Detecting Motion Along the X Direction

In some instances, the motion along X-axis may correspond to either left or right taps. In one embodiment, the absolute X jerk can be compared to a minimum threshold (e.g., determined by the minimum signal strength feature 715), followed by comparison of X jerk with the jerk on Y and Z axes. For example, in the clean signal, X will be the dominant jerk and the axis can be easily identified.

In another embodiment, the Z gyroscope angular acceleration, from the source signal of gyroscope 145, is compared to a minimum threshold (e.g., determined by the minimum signal strength feature 715), followed by checks comparing the Z gyroscope angular acceleration to X and Y gyroscope angular acceleration.

Additionally, if the acceleration or gyroscope minimum thresholds are surpassed during the soft decision, a more detailed check may be initiated with higher thresholds and stricter conditions. If the stricter conditions are met, during the final decision, the tap is clearly a left/right type. If both the preliminary tests and the strict tests are met, the taps are classified as true left or right, else they are of type UNKNOWN and further checks are done for top or bottom.

In some cases (e.g., depending on the device, sensor location), a tap may be identified as left or right tap based on the initial preliminary minimum tests during a soft decision determination. When tuning the sensors to the device 100, there may be a mismatched number of taps (e.g., right/left or top/bottom) detected during a user interactive session. For example, a training data set may request a user to tap multiple times on one side of the device. If the device detects more or less than the anticipated number of taps, the tap detection threshold (TDT) may be set too low or too high and can be adjusted. Additionally, the TDT may be influenced by the SNR feature 720 or the minimum signal strength feature 715. In some embodiments, the TDT may be referenced as or may be equivalent to the sensitivity threshold.

Additionally, left or right taps may be more distinctive and strong when compared to top or bottom taps. According to some embodiments, the thresholds for left and right tap detection may be higher than thresholds for top and bottom tap detection.

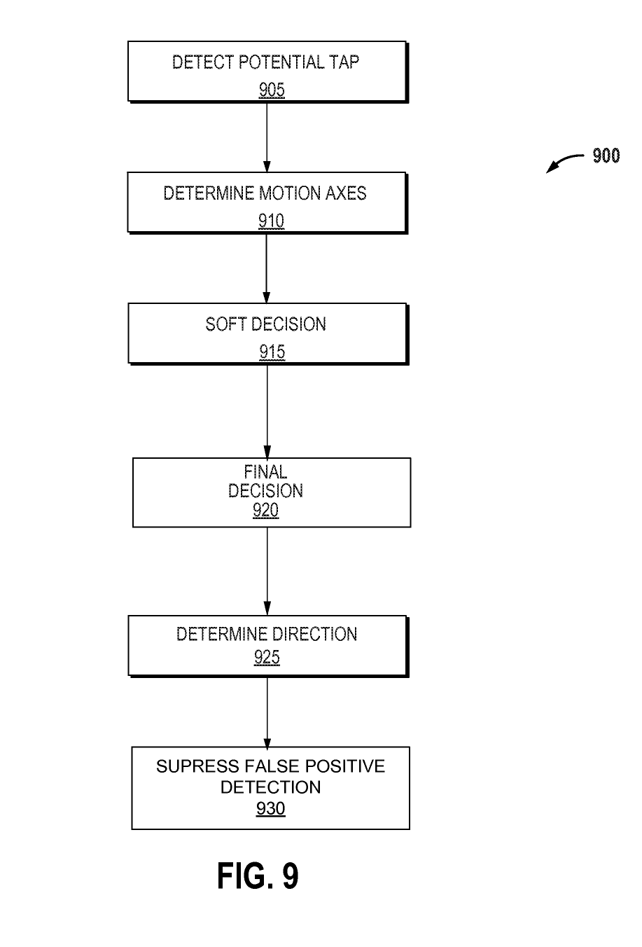

In one embodiment, after completing the axes determination, a soft decision is made. For example, a determination of whether left or right taps has occurred can be a soft decision. Furthermore, if the above conditions are satisfied for a soft decision, a left/right axis flag is set. Alternatively, if the above conditions are not satisfied, the left/right axis flag is reset. Once the left/right axis is set, according to some embodiments, the process continues to determine a final decision, as will be later described in FIG. 9.

### ii. Detecting Motion Along the Y Direction

In some embodiments, motion along Y-axis corresponds to top or bottom taps. For example, if the Y jerk is stronger than a minimum threshold, and Y jerk is stronger than X and Z jerks, the tap may be classified as a clear top or bottom type tap.

Furthermore, the top or bottom taps may have a smaller magnitude threshold than left or right taps, but are computed using a similar approach as above for the X-axis.

In another embodiment, the gyroscope angular acceleration, from the source signal of gyroscope 145, is compared to a minimum threshold (e.g., determined by the minimum signal strength feature 715), followed by checks comparing the gyroscope angular acceleration to the other axes of the gyroscope angular acceleration.

Additionally, if the tap is not classified as top or bottom, and is of type UNKNOWN, a second attempt is made to classify these with lower thresholds. If the lower threshold conditions are satisfied, the tap can be identified as top or bottom type.

Moreover, the motion along Y-axis may correspond to either top or bottom taps. To detect this axis of motion, the absolute Y jerk may be compared to a minimum threshold, followed by comparison of Y jerk with the jerk on X and Z axes. In the clean signal, Y-axis may be the dominant jerk and the axis of the tab can be determined based on the Y-axis jerk.

In one embodiment, after completing the axes determination, a soft decision is made. For example, a determination of whether top or bottom taps has occurred can be a soft decision. Furthermore, if the above conditions are satisfied for a soft decision, a top/bottom axis flag is set. Alternatively, if the above conditions are not satisfied, the top/bottom axis flag is reset. Once the top/bottom axis is set, according to some embodiments, the process continues to determine a final decision, as will be later described in FIG. 9.

### iii. Detecting Motion Along the Z Direction

In some embodiments, the Z direction is considered noise that adversely affects the X and Y tap determination. When the Z direction is considered noise and a determination is made that the strongest motion is detected in the Z-axis, MAM 810 may lower the thresholds for determining the X-axis and Y-axis motion and recalculate the X and Y axis motion determination. In another embodiment, when the Z-axis is determined to contain the strongest motion, MAM 810 determines that no tap has occurred.

In alternate embodiments, when TEM 730 allows front and back tap detection and direction determination, MAM 810 may process taps similarly as detailed above for the X and Y axis. Motion along the Z-axis may correspond to front and back taps and the absolute jerk is compared to a minimum threshold, followed by a comparison of the Z jerk with the Y and X axes.

In another embodiment, the gyroscope angular acceleration, from the source signal of gyroscope 145, is compared to a minimum threshold (e.g., determined by the minimum signal strength feature 715), followed by checks comparing the gyroscope angular acceleration to the other axes of the gyroscope angular acceleration.

C. Axes Anomaly Module

Axes anomaly module (AAM) 815 can detect axis anomaly. Axis anomaly can be detected based on data (jerk, angular acceleration) from either the accelerometer 140 or the gyroscope. For example, when Z-axis tap detection is disabled, Z-anomaly detection can be enabled using AAM 815. Z-anomaly detection can be enabled by setting a flag and a Z-jerk minimum threshold. Signal and linear acceleration may leak into the Z-axes even when the expected strong signal is in the X or Y directions. A strong Z-signal may be caused by sensor placement/signal leakage, phone orientation or user tap behavior.

For example, depending on the particular device and sensor placement, there may be direct correlation between Z-jerk and top or bottom tap. In some embodiments, after determining a possible top or bottom tap, AAM 815 checks to determine the strength/magnitude of the Z-jerk in the absolute sense as well as relative to X and Y jerk values. If the above strong anomaly does not exist, AAM 815 can compare the Z-jerk to X and Y jerk values using lower thresholds. In another embodiment, the comparison may be equivalent to ignoring the Z jerk and continue the search for X and Y jerks to identify the two main axes of motion. If none of the criteria are met, the axes are either identified as unknown, or marked as top/bottom based on the top/bottom flag.

In one embodiment, final decision determination can be based on the results from several checks for each axis, and combines the flags for left/right and top/bottom to decide the axes. For example, if both X and Y axes are found ‘true’ (e.g., their respective flags are set), the final state can be set to UNKNOWN.

Alternatively, if a tap is not detected, another determination can be made with lower thresholds in order to make a decision. Recalculating the tap with lower thresholds may result in a less accurate determination and may be optional in some implementations.

D. Tap Direction Module

After a soft decision determination (e.g., after the final axis of motion is determined), tap direction module 820 can calculate the direction of tap for a final decision determination. Tap direction module 820 can determine the direction of the tap based on the sign of the jerk corresponding to the start/beginning of the tap. For example, a positive X axis jerk can be determined as a left tap, while a negative X axis jerk can be determined to be a right tap. A positive Y axis jerk can be determined as a bottom tap, while a negative Y axis jerk can be determined to be a top tap.

In some embodiments, the direction determination is made based on the beginning of detected tap. When a first time jerk magnitude exceeds a direction tap threshold, the jerk vector can be stored for determining direction. At the beginning of the tap, tap direction module 820 may not yet have an accurate determination of whether the tap detected is a valid tap. The end of the potential tap can be detected when the absolute jerk magnitude falls below a tap threshold. After a potential tap is determined as being a legitimate tap, the direction is determined based on the stored jerk values at the beginning of the tap. For example, the direction can be determined at the end of the tap, but based on the jerk stored at the beginning of the tap.

Additionally, the timing impact of the sensitivity threshold can be decoupled from the intended tap threshold functionality. For example, the sensitivity threshold may determine the start and end points of a potential tap, while the maxima of the jerk magnitude between the initial start and end points of a tap determine whether the potential tap is an actual tap. In one embodiment, tap direction module 820 can determine a jerk magnitude for potential taps (e.g., taps with signal strength>0.1-0.2 G-force). For example, the tap beginning and tap end may be determined before calculating the jerk magnitude. Therefore, sensor data can be buffered before being processed. When the maxima of the jerk magnitude are greater than the tunable sensitivity threshold, a tap may be determined to be an actual tap. After determining an actual tap, the direction can be determined from the jerk stored at the beginning of the tap.

Furthermore, determining the direction of the tab after determining an actual tab has occurred can reduce noise without impacting performance. In current implementation, when sensitivity threshold is changed in order to avoid typing, or noisy taps or other noise, the direction computation of the previously correct taps may also be impacted. Therefore, by determining the direction after an actual tab is determined, tap direction module 820 can provide more accurate determination for the direction of the tap.

E. Tap Rejection Module

According to some embodiments, TEM 703 or TDM 805 may initially determine that a received jerk input is a potential tap. However, based on the data received from the MAM 810, AAM 815 and tap direction module 820, the potential tap can be classified as a false detection. Thus, when the potential tap is classified as a false detection, the Tap Rejection Module (TRM) 825 can be used to suppressing a tap that has been classified as a false detection. Additionally, a tap classified as a false detection can also be known as a false tap.

Furthermore, a tap (e.g., false tap) can be classified as a false detection when the orientation of device 100 changes. As previously mentioned, the orientation of the device 100 changing can be determined based on the data received from the MAM 810, AAM 815 and tap direction module 820. For example, changing device 100 orientation quickly from landscape to portrait mode, vice versa, or changing to another orientation can cause TEM 730 or TDM 805 to make an initial determination (e.g., soft decision 915) that a potential tap has occurred. Subsequently, after receiving data from MAM 810, AAM 815 and tap direction module 820, TEM 730 can make a final determination (e.g., final decision 920). When the final determination classifies the potential tap as a false detection (e.g., based on the detection of an orientation change), TEM 730 can override or change the determination that a tap occurred, and use TRM 825 to suppress the tap that has been classified as a false detection.

In some instances, TRM 825 can process gyroscope data and detects a change in orientation at or near the time of the false tap and makes the determination that it is unlikely that a tap occurs during or near to an orientation change. For example, a user may switch a device from portrait to landscape mode quickly enough to cause TEM 730 to initially detect a tap which is then suppressed or subject to an override by TRM 825 based on the temporal proximity to an orientation change.

In another embodiment, TRM 825 can process gyroscope data over short intervals to minimize the impact of gyroscope calibration errors. In some instances, if the integrated gyroscope angle exceeds a minimum threshold for a window or point in time, a flag is set for the window or point in time to indicate a false tap may have occurred. For example, TRM 825 may flag orientation changes such that TEM 730 can check for a flag before making a determination that a tap is detected. If a tap is detected within an interval at or near where the orientation rejection flag was set, the tap can be rejected. Thus, taps in the temporal vicinity of an orientation change can be rejected because of the high likelihood of false alarms.

In another embodiment, gestures such as push, pull, and shake are also filtered out as false taps. For example TRM 825 may detect and flag a gesture (e.g., push, pull, and shake) in close temporal proximity to a detected tap so that the detected tap may be suppressed or subject to override. A person of skill in the art will recognize that other gestures may be possible to be classified as a false detection tap, and the gestures mentioned here are merely examples. In one embodiment, when a gesture is recorded at a point in time (e.g., a timestamp) or a window of time, a determination is made as to the likelihood of a tap occurring at the same point in time or window of time. For example, the gesture may have to meet a minimum threshold or magnitude in order to suppress or override the determination that a tap occurred. In other embodiments, when a gesture and a tap occur within a predetermined window of time, the tap is determined to be a false tap.

FIG. 9 illustrates a simplified flowchart 900 for tap detection and direction determination using TEM 730 described in FIGS. 7 and 8. At 905, TEM 730 can detect a potential tap. For example, TEM 730 can use TDM 805 to detect a potential tap.

At 910, TEM 730 can determine motion axes based on the detected potential tap. For example, TEM 703 can use MAM 810 to determine motion axes. At 915, TEM 730 can create a soft decision based on the determined motion of axes X, Y, and Z. For example, the soft decision may be stored in a temporary storage area, or may be implemented as a temporary flag assigned to the signal or sensor data as it is processed by TEM 730. Later, after the soft decision is confirmed or denied, the flag may be removed or the temporary storage details associated with the soft decision can be removed. Additionally, a soft decision can be an initial assessment of a tap in the X-axis or Y-axis direction, without the positive or negative magnitude determination of the tap direction.

At 920, TEM 730 determines whether the soft decision can be converted to a final decision. For example, the soft decision may determine that the tap is in the X-axis direction, and the final decision confirms the determination made by the soft decision and further determines that the tap has a positive magnitude in the X-axis direction. As previously described, a positive magnitude on the X-axis may indicate a tap on the left edge of the device 100. In some instances, TEM 730 can use AAM 815 and tap direction module 820 to determine a final decision.

Additionally, at 925, TEM can determine the direction of the tap. For example, TEM 730 can use tap direction module 820 to determine the direction of the tap. In some instances, if two axes are determined to be the motion axes, a final decision may be postponed and further calculations may be required to determine the motion of axes. Furthermore, at 925, TEM 730 can classify a potential tap (e.g., determination at 920) as a false detection based on the sensor data received from accelerometer 140 and gyroscope 145. Moreover, the sensor data received from accelerometer 140 and gyroscope 145 can be used by MAM 810, AAM 815 and tap direction module 820 to help TEM 730 with the classification of the potential tap as a false detection.

Furthermore, at 930, when the tap has been classified as a false detection, TEM 730 can suppress false positive detection. For example, TEM 730 can use TRM 825 to suppress false positive detection.

According to one embodiment, windowed jerk feature 710, minimum signal strength feature 715 and signal-to-noise ratio feature 720 can be used in tap detection module 805, motion axes module 810 and axes anomaly module 815. Additionally, motion axes module 810 and axes anomaly module 815 can be used in the soft decision determination 915. The tap direction module 820 can be used in the final decision determination 920.

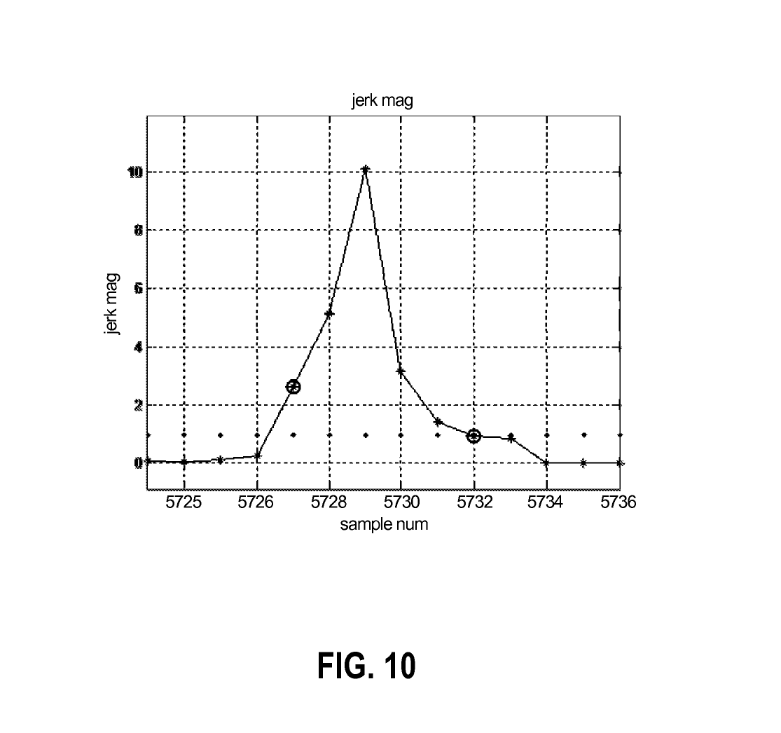

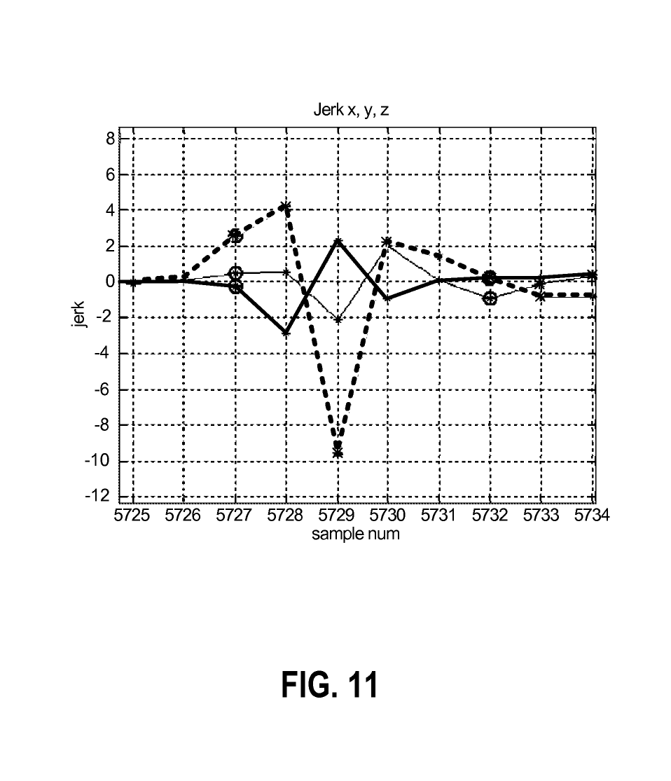

FIG. 10 and FIG. 11 illustrate the impact of tap detection timing errors, according to some embodiments. For example, moving one or two samples can result in missing the peak illustrated in FIG. 10 and FIG. 11. Taps can be very short duration events; therefore, if the sample is recorded or processed out of sync with the actual tap, the rising peak may be missed causing TEM 730 to miss the trigger for determining a tap. As illustrated in FIG. 10, the data (e.g., jerk, angular acceleration) from accelerometer 140 or gyroscope 145 was not sampled at a high enough frequency; therefore TEM 730 may miss determining that a tap has occurred. Alternatively, FIG. 11 illustrates the same data (e.g., jerk, angular acceleration) from accelerometer 140 or gyroscope 145, but sampled at a higher frequency in comparison to FIG. 10. Thus, TEM 730 may be able to better determine an occurrence of a tap based on the data illustrated in FIG. 11.

In one embodiment, modules or engines described herein (e.g., TEM 730) can be implemented in software, hardware (e.g., as an element of device 100), or as a combination of software and hardware. For example, the modules may be implemented in the processor 101 and/or memory 105. In one embodiment, the TEM 730 can interface with or access one or more sensor(s) 185 (e.g., sensors integrated or coupled to device 100).

### III. Data Tuning

In some embodiments, device 100 can be tuned with a training data set. For example, device 100 is held as horizontal with the display upright and subjected to right taps at the center of the right edge as well as random tap distributions along the right edge. The training procedure can be repeated with the left tap/left edge, top tap/top edge, bottom tap/bottom edge. In other embodiments the front and back of the device 100 can also receive taps as described above, and therefore may also have a related training data set.

Training information collected can be recorded or saved to a training data set so that device 100 and TEM 730 can recognize similar tap signatures for future events. All training information can be collected in the same manner for consistency. For example, the training may occur while the raw accelerometer and gyroscope data are sampled at 200 Hz, the device is held by the user in portrait mode, and the device is maintained nearly stationary and orientation changes are avoided. In some embodiments, finger nails and non-finger nail taps are recorded, and may be recorded in separate training data sets.

Furthermore, after the training data set is recorded, a benchmark table can be provided to allow for further tuning For example, if some taps that were supposed to be recorded were missed, recording thresholds may be adjusted accordingly (e.g., the sensitivity threshold). In some embodiments, when an application or program integrates on-screen user interactions with tap gestures, a Z-anomaly threshold can be adjusted to allow for greater filtering of on-screen taps from left/right and top/bottom taps.

It should be appreciated that when the device 100 is a mobile or wireless device, it may communicate via one or more wireless communication links through a wireless network that are based on or otherwise support any suitable wireless communication technology. For example, in some aspects, a computing device or server may associate with a network including a wireless network. In some aspects the network may comprise a body area network or a personal area network (e.g., an ultra-wideband network). In some aspects the network may comprise a local area network or a wide area network. A wireless device may support or otherwise use one or more of a variety of wireless communication technologies, protocols, or standards such as, for example, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web-sites, etc.

The teachings herein may be incorporated into (e.g., implemented within or performed by) a variety of apparatuses (e.g., devices). For example, one or more aspects taught herein may be incorporated into a phone (e.g., a cellular phone), a personal data assistant (PDA), a tablet, a mobile computer, a laptop computer, a tablet, an entertainment device (e.g., a music or video device), a headset (e.g., headphones, an earpiece, etc.), a medical device (e.g., a biometric sensor, a heart rate monitor, a pedometer, an Electrocardiography (EKG) device, etc.), a user I/O device, a computer, a server, a point-of-sale device, an entertainment device, a set-top box, or any other suitable device. These devices may have different power and data requirements and may result in different power profiles generated for each feature or set of features.

In some aspects a wireless device may comprise an access device (e.g., a Wi-Fi access point) for a communication system. Such an access device may provide, for example, connectivity to another network (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof If implemented in software as a computer program product, the functions may be stored on or transmitted over as one or more instructions or code on a non-transitory computer-readable medium. Computer-readable media can include both computer storage media and communication media including any medium that facilitates transfer of a computer program from one place to another. A storage media may be any available media that can be accessed by a computer. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method, comprising:
receiving a first data sample from an accelerometer sensor;
receiving a second data sample from a gyroscope sensor;
processing a plurality of data samples, wherein the plurality of data samples includes the first data sample or the second data sample; and
determining an occurrence of a tap at a mobile device based on the results of the processing.

2. The method of claim 1, wherein the determining further comprises:
suppressing a tap that has been classified as a false detection based on at least one of the plurality of data samples.

3. The method of claim 2, wherein the suppressing further comprises:
detecting, based on the second data sample from the gyroscope sensor, an orientation change within a time threshold of a potential detection of a tap; and
suppressing the tap associated with the false detection classification based on the detected orientation change.

4. The method of claim 2, wherein the plurality of data samples further includes a gesture recognition data sample, and the suppressing is further based on the gesture recognition data sample.

5. The method of claim 1, wherein the processing further comprises:
calculating a windowed jerk, wherein the windowed jerk is the difference between the maxima and minima of the first data sample from the accelerometer sensor.

6. The method of claim 1, wherein the processing further comprises:
calculating an angular acceleration, wherein the an angular acceleration is the difference between the maxima and minima of the second data sample from the gyroscope sensor.

7. The method of claim 1, wherein the determining further comprises:
determining a minimum signal strength; and
comparing the first data sample with the minimum signal strength to determine whether a tap has occurred.

8. The method of claim 1, wherein the determining further comprises:
determining a minimum signal strength; and
comparing the second data sample with the minimum signal strength to determine whether a tap has occurred.

9. The method of claim 1, wherein the determining further comprises:
calculating a signal-to-noise ratio; and
comparing the first data sample with the signal-to-noise ratio to determine whether a tap has occurred.

10. The method of claim 9, wherein the signal-to-noise ratio is a jerk magnitude from an axis divided by a jerk magnitude from one or more other axes.

11. The method of claim 1, wherein the determining further comprises:
calculating a signal-to-noise ratio; and
comparing the output of the processing of the second data sample with the signal-to-noise ratio to determine whether a tap is detected.

12. The method of claim 11, wherein the signal-to-noise ratio is an angular acceleration magnitude from an axis divided by an angular acceleration magnitude from one or more other axes.

13. The method of claim 1, wherein the results of the processing include an axis of motion of the tap based on the first and second data samples.

14. The method of claim 1, wherein the results of the processing includes a sign of motion of the tap based on the first data sample.

15. The method of claim 1, wherein the detection of a tap comprises a left tap, a right tap, a top tap and a bottom tap detection relative to a front surface of the mobile device.

16. The method of claim 1, wherein the detection of a tap comprises ignoring a front and a back tap detection relative to a front surface of the mobile device.

17. The method of claim 1, wherein a representation of the direction of the tap is sent to an application, wherein the application uses the direction as a user input.

18. A device comprising:
one or more processors;
memory storing computer-readable instructions that, when executed by the one or more processors, cause the device to:
receive a first data sample from an accelerometer sensor;
receive a second data sample from a gyroscope sensor;
process a plurality of data samples, wherein the plurality of data samples includes the first data sample or the second data sample; and
determine an occurrence of a tap at a mobile device based on the results of the processing.

19. The device of claim 18, further comprising computer-readable instructions that, when executed by the one or more processors, cause the device to:
suppress a tap that has been classified as a false detection based on at least one of the plurality of data samples.

20. The device of claim 19, further comprising computer-readable instructions that, when executed by the one or more processors, cause the device to:
detect, based on the second data sample from the gyroscope sensor, an orientation change within a time threshold of a potential detection of a tap; and
suppress the tap associated with the false detection classification based on the detected orientation change.

21. The device of claim 19, wherein the plurality of data samples further includes a gesture recognition data sample, and the suppressing is further based on the gesture recognition data sample.

22. The device of claim 18, further comprising computer-readable instructions that, when executed by the one or more processors, cause the device to:
calculate a windowed jerk, wherein the windowed jerk is the difference between the maxima and minima of the first data sample from the accelerometer sensor.

23. The device of claim 18, further comprising computer-readable instructions that, when executed by the one or more processors, cause the device to:
calculate an angular acceleration, wherein the angular acceleration is the difference between the maxima and minima of the second data sample from the gyroscope sensor.

24. The device of claim 18, further comprising computer-readable instructions that, when executed by the one or more processors, cause the device to:
determine a minimum signal strength; and
compare the first data sample with the minimum signal strength to determine whether a tap has occurred.

25. The device of claim 18, further comprising computer-readable instructions that, when executed by the one or more processors, cause the device to:
determine a minimum signal strength; and
compare the second data sample with the minimum signal strength to determine whether a tap has occurred.

26. The device of claim 18, further comprising computer-readable instructions that, when executed by the one or more processors, cause the device to:
calculate a signal-to-noise ratio; and
compare the first data sample with the signal-to-noise ratio to determine whether a tap has occurred.

27. The device of claim 26, wherein the signal-to-noise ratio is a jerk magnitude from an axis divided by a jerk magnitude from one or more other axes.

28. The device of claim 18, further comprising computer-readable instructions that, when executed by the one or more processors, cause the device to:
calculate a signal-to-noise ratio; and
compare the output of the processing the second data sample with the signal-to-noise ratio to determine whether a tap is detected.

29. The device of claim 28, wherein the signal-to-noise ratio is an angular acceleration magnitude from an axis divided by an angular acceleration magnitude from one or more other axes.

30. The device of claim 18, wherein the results of the processing include an axis of motion of the tap based on the first and second data samples.

31. The device of claim 18, wherein the results of the processing includes a sign of motion of the tap based on the first data sample.

32. The device of claim 18, wherein the detection of a tap comprises a left tap, a right tap, a top tap and a bottom tap detection relative to a front surface of the mobile device.

33. The device of claim 18, wherein the detection of a tap comprises ignoring a front and a back tap detection relative to a front surface of the mobile device.

34. The device of claim 18, wherein a representation of the direction of the tap is sent to an application, wherein the application uses the direction as a user input.

35. One or more computer-readable media storing computer-executable instructions for detecting a tab in a mobile device that, when executed, cause one or more computing devices included in the mobile device to:
receive a first data sample from an accelerometer sensor;
receive a second data sample from a gyroscope sensor;
process a plurality of data samples, wherein the plurality of data samples includes the first data sample or the second data sample; and
determine an occurrence of a tap at a mobile device based on the results of the processing.

36. An apparatus for detecting a tap in a mobile device, the apparatus comprising:
means for receiving a first data sample from an accelerometer sensor;
means for receiving a second data sample from a gyroscope sensor;
means for processing a plurality of data samples, wherein the plurality of data samples includes the first data sample or the second data sample;
means for determining an occurrence of a tap at a mobile device based on the results of the processing.

37. The apparatus of claim 36, wherein the means for determining further comprises:
means for suppressing a tap that has been classified as a false detection based on at least one of the plurality of data samples.

38. The apparatus of claim 37, wherein the suppressing further comprises:
means for detecting, based on the second data sample from the gyroscope sensor, an orientation change within a time threshold of a potential detection of a tap; and
means for suppressing the tap associated with the false detection classification based on the detected orientation change.

39. The apparatus of claim 37, wherein the plurality of data samples further includes a gesture recognition data sample, and the suppressing is further based on the gesture recognition data sample.

40. The apparatus of claim 36, wherein the means for processing further comprises:
means for calculating a windowed jerk, wherein the windowed jerk is the difference between the maxima and minima of the first data sample from the accelerometer sensor.

41. The apparatus of claim 36, wherein the processing further comprises:
calculating an angular acceleration, wherein the angular acceleration is the difference between the maxima and minima of the second data sample from the gyroscope sensor.

42. The apparatus of claim 36, wherein the determining further comprises:
determining a minimum signal strength; and
comparing the first data sample with the minimum signal strength to determine whether a tap has occurred.

43. The apparatus of claim 36, wherein the determining further comprises:
determining a minimum signal strength; and
comparing the second data sample with the minimum signal strength to determine whether a tap has occurred.

44. The apparatus of claim 36, wherein the determining further comprises:
calculating a signal-to-noise ratio; and
comparing the first data sample with the signal-to-noise ratio to determine whether a tap has occurred.

45. The apparatus of claim 44, wherein the signal-to-noise ratio is a jerk magnitude from an axis divided by a jerk magnitude from one or more other axes.

46. The apparatus of claim 36, wherein the determining further comprises:
calculating a signal-to-noise ratio; and
comparing the output of the processing of the second data sample with the signal-to-noise ratio to determine whether a tap is detected.

47. The apparatus of claim 46, wherein the signal-to-noise ratio is an angular acceleration magnitude from an axis divided by an angular acceleration magnitude from one or more other axes.

48. The apparatus of claim 36, wherein the results of the processing includes an axis of motion of the tap based on the first and second data samples.

49. The apparatus of claim 36, wherein the results of the processing includes a sign of motion of the tap based on the first data sample.

50. The apparatus of claim 36, wherein the detection of a tap comprises a left tap, a right tap, a top tap and a bottom tap detection relative to a front surface of the mobile device.

51. The apparatus of claim 36, wherein the detection of a tap comprises ignoring a front and a back tap detection relative to a front surface of the mobile device.

52. The apparatus of claim 36, wherein a representation of the direction of the tap is sent to an application, wherein the application uses the direction as a user input.
